(19) United States
(12) Patent Application Publication
(10) Pub. No.: US 2005/0114435 A1
(43) Pub. Date: May 26, 2005

(54) Web-based deployment of context sensitive navigational elements within a user interface

(75) Inventors: Marco DiPlacido, Waltham, MA (US); Eric Alan Smith, Sumner, WA (US)

Correspondence Address: Joseph R. Kelly;Westman, Champlin & Kelly, Suite 1600, 900 Second Avenue South, Minneapolis, MN, 55402-3319, US

(73) Assignee: Microsoft Corporation, Redmond, WA (US)

(21) Appl. No.: 10/992,318

(22) Filed: Nov. 18, 2004

Related U.S. Application Data
(60) Provisional application No. 60/524,289, filed on Nov. 21, 2003.

(51) Int. Cl. G06F 15/16

(52) U.S. Cl. 709/202; 709/201; 709/203

(57) ABSTRACT

A system for generating a user interface for display over a network on a user device includes a skeleton file and one or more web servers. The skeleton file contains embedded tags and placeholders. The embedded tags define types of information and control elements. The placeholders define a layout of the user interface. The one or more web servers are adapted to populate the embedded tags with information and control elements based on interactions of a user.

### CROSS-REFERENCE TO RELATED APPLICATION(S)

This application claims priority from provisional patent application No. ______, filed on Nov. 21, 2003 and entitled “WEB-=BASED DEPLOYMENT OF CONTEXT SENSITIVE NAVIGATIONAL ELEMENTS WITHIN A USER INTERFACE”.

### BACKGROUND OF THE INVENTION

The present invention relates to network-based user interfaces, and more particularly, to deployment of user interfaces within web pages over a network.

Generally, the phrase “user interface” (UI) refers to all elements provided in an information device with which a human being may interact. For example, a user interface may include physical elements such as a display screen, a keyboard, a mouse, a pen device, and the like. A user interface may also include, for example, graphical or textual objects displayed on the display screen, such as icons, buttons, menus, characters, the “desktop” of the operating system on a computer, and the like. Finally, the user interface may include, for example, the look and feel of how an application program or a Web site invites interaction from a user and how the application program or Web site responds to such user interaction. One of the primary goals of user interface design is to provide a host of functions to a user in a simple, intuitive form.

One way that such interfaces have been implemented is by using Standard Generalized Markup Language (SGML) or Hypertext Markup Language (HTML) in conjunction with available Internet web browsers. The user interface itself can be defined in extensible Markup Language (XML), which can be displayed by a web browser. However, maintaining a consistent web page interface across an entire enterprise has traditionally been difficult, particularly with respect to navigational elements, such as navigational links, buttons, menu bars, and the like.

For example, as a user advances through various layers of a web page or site, the navigational elements, in addition to the content of the page, are expected to change accordingly. Traditionally, such contextual navigational elements had to be coded into the HTML code of each page, a process that tended to be time consuming, error prone, and expensive in terms of employee time.

There is an on-going need for improvements in the delivery of contextual navigational elements within Internet and Intranet web sites. Moreover, there is a need for improvements in the consistency of that delivery across multiple services and servers within an enterprise. Embodiments of the present invention provide solutions to these and other problems, and offer other advantages over the prior art.

### SUMMARY OF THE INVENTION

A system for generating a user interface for display over a network on a user device includes a skeleton file and one or more web servers. The skeleton file contains embedded tags and placeholders. The embedded tags define types of information and control elements. The placeholders define a layout of the user interface. The one or more web servers are adapted to populate the embedded tags with information and control elements based on interactions of a user.

### BRIEF DESCRIPTION OF THE DRAWINGS

FIG. 1 is a diagrammatic view of a computing system environment on which an embodiment of the present invention may be implemented.

FIG. 2 is a simplified block diagram of a network user interface with which embodiments of the present invention are particularly useful.

FIG. 3 is a more detailed block diagram of a system for generating a user interface in accordance with an embodiment of the present invention.

FIG. 4 is a simplified flow diagram of an embodiment of the present invention from a perspective of service team installation.

FIG. 5 is a simplified flow diagram of an embodiment of the present invention from the perspective of a web browser.

FIG. 6 is a screen view of a web page generated according to an embodiment of the present invention.

FIGS. 7A-7C illustrate changes in navigational element based on user interactions with the navigation pane.

FIG. 8 illustrates an alternative embodiment of a system according to the present invention.

### DETAILED DESCRIPTION OF ILLUSTRATIVE EMBODIMENTS

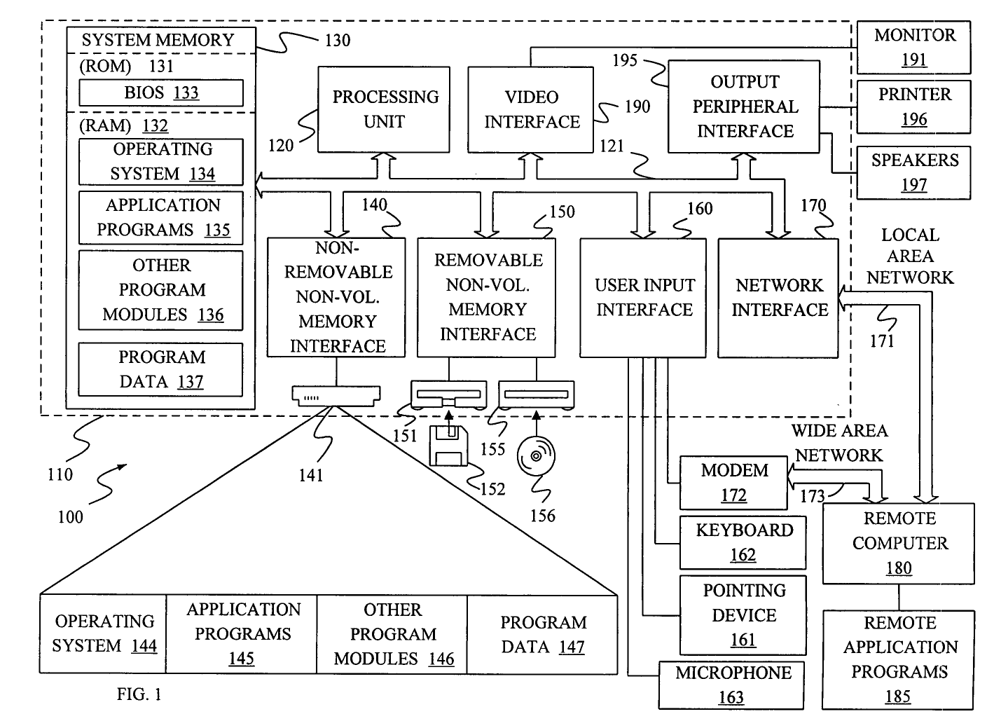

Prior to describing the present invention in detail, one embodiment of an environment in which it can be used is described. FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

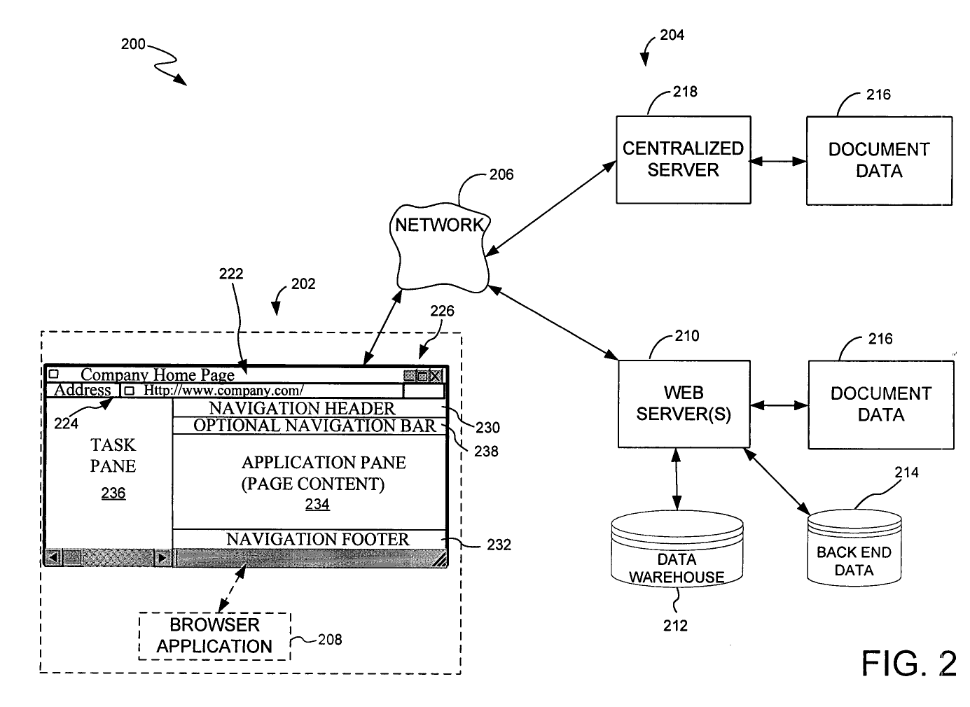

FIG. 2 illustrates a simplified block diagram of a system 200 for assembling a user interface according to an embodiment of the present invention. The system 200 includes a client device 202 coupled to one or more servers 204 via network 206. The client device 202 is any device capable of interpreting a markup language code (SGML, HTML, and the like) and displaying information based on the markup language code to a user. The present discussion proceeds with respect to the code being SGML/HTML, but it will be appreciated that the inventive aspects of the invention are not so limited, and other markup languages can be used as well. For simplicity, in this embodiment, the client device 202 is a computer with a display. The computer 202 includes elements such as those described with respect to FIG. 1. Additionally, the client device includes a web browser application 208.

The network 206 can be a local area network, a wide area network, a public switched network (such as a telephone network), the Internet, or any other network type. In general, the network 206 is simply the communication medium by which the computer 202 and the one or more servers 204 interact.

In this embodiment, the web browser application 208 has been instantiated by a user, and the browser application 208 is accessing information from a number of data sources, including one or more web servers 210 (which in one illustrative embodiment can be implemented using Microsoft Exchange available from Microsoft Corporation of Redmond, Wash.), and a data warehouse 212 (which can illustratively be implemented using Structured Query Language (SQL)) with back end data 214 and document data 216. Data sources may include the Internet, a network-based e-mail server (such as a web-mail server), relational data in a server table of a relational database, and the like. Each application or service within an enterprise, for example, may have its own set of web servers 210, and preferably there is a centralized server 218 that provides (“serves”) the header and footer. Generally, any type of information that can be presented in the form of a browser or web page may be provided in a web-part such as the header or footer. A uniform resource locator (URL) is well-known type of basic information that can be considered a web-part.

Generally, information provided by the centralized server 218 is displayed by the browser application 208 in a browser window 220 on a display of the client device or computer 202. In this embodiment, the browser window 220 includes a title pane 222 and one or more tool bars 224. Generally, the title pane 222 provides three buttons 226 in its upper right-hand corner, which allow a user the option of minimizing (shrinking), maximizing (enlarging) or closing the browser window 220. The title pane 222, tool bar 224, including clickable buttons, and URL line 230 are conventional browser control features offered within an Internet browser application, though other control elements could be provided in the browser window 220 to offer browser specific functionality to the user.

The browser window 220 displays a web page having several navigational elements: a header 230, a footer 232, an application pane 234, a navigation (task) pane 236, and an optional navigation pane 238. Typically, the header 230 contains product branding, global user interface navigational elements that are required by the sales brand, and some local user interface branding and navigational elements that apply to the service in use. The footer 232 typically includes global navigational elements, which commonly include links such as “privacy statements”, “terms of use”, and links to various help topics. The application pane 234 refers to the main body of the page. Finally, the navigation (task) pane 236 contains context-based navigational features, which may change according to user interactions. Additionally, the optional navigation pane 238 could be provided below the header 230 to provide additional navigational elements.

Generally, the navigation pane 236, the header 230, the footer 232, and the second navigation pane 238 can be rendered, for example, by the centralized server 218 from a centrally stored document. Thus, the user interface can be defined and rendered from a single file, such that changes to the user interface need only be made in one place, to a single file, in order to effect a change immediately across all services and for all users. By rendering the navigational elements from a single file, the present invention provides a means for instantly updating the user interface for an entire enterprise with a consistent look and feel, while minimizing the number of pages requiring re-coding in order to effect the change.

Alternatively, each of the one or more web servers 210 renders web pages associated with a particular service. The web servers 210 can access the centralized server 218 to assemble navigational elements for the header 230, the footer 232, the application pane 234, and the navigation pane 236, as well as the optional navigation bar 238. In this manner, enterprise specific navigation elements can be derived from information on the centralized server 218, while service specific navigational elements can be derived from the one or more web servers 210 as needed.

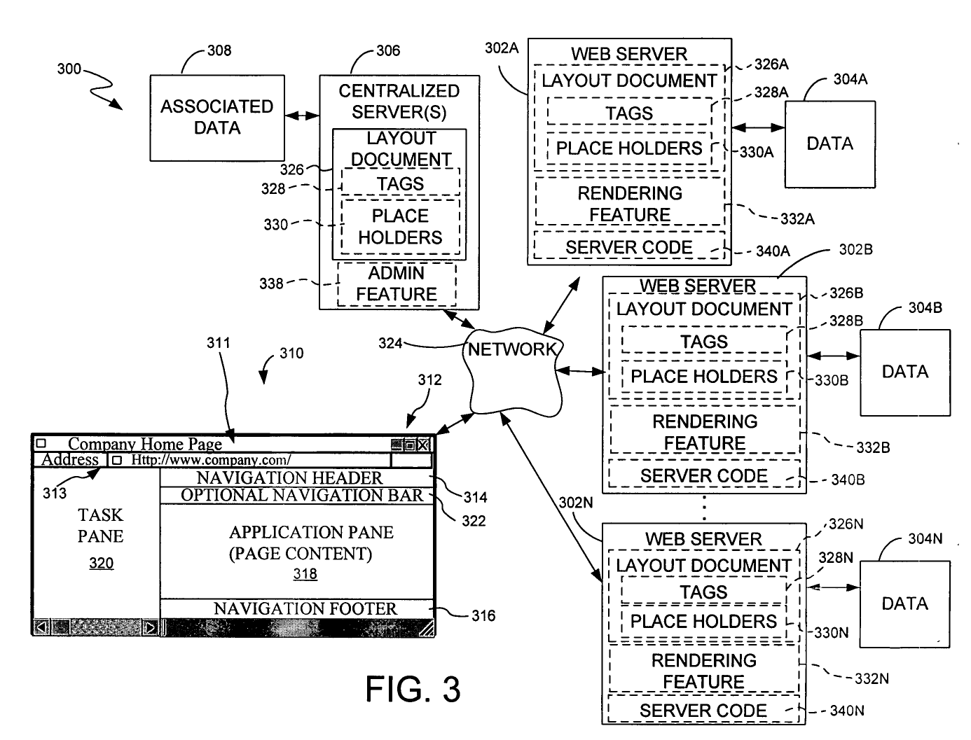

Referring now to FIG. 3, a system 300 for dynamically assembling a web page with context sensitive navigational elements is shown. The system 300 includes a plurality of web servers (service servers) 302A-302N with associated data 304A-304N, one or more centralized servers (enterprise servers) 306 with associated data 308, and an Internet browser view 310 (or window) that is dynamically assembled from the data associated with at least one service server 302 and at least one of the one or more centralized servers 306. The browser view (window) 310 includes a title pane 311 with window sizing control buttons 312 and an address tool bar 313. The displayed document within the browser window 310 includes a header 314, a footer 316, an application pane 318, and a navigation pane 320. Optionally, a second navigation pane 322 may be added below the header 314, above the footer 316 or in any other logical location within the window 310.

The elements contained within the browser window 310 are rendered by a web (service) server 302 and served to the Internet browser, for example, of a client device over network 324. The network 324 can be any type of network, including but not limited to wireless (cellular, satellite, digital, and the like) or wired (local area, wide area, and the like). In one embodiment, the network 324 is the Internet.

A layout structure of a typical server page is stored in one or more (typically one) “skeleton” HTML or SGML documents 326 on, for example, the centralized server 306. Centralized server 306 may be a single server or one or more servers that, for example, mirror one another. For example, the one or more centralized servers 306 may be load balanced behind, for example, a domain name server (not shown). The skeleton file 326 is preferably stored on the one or more centralized servers 306 and downloaded to the web servers 302 (as needed or periodically) to be used as a user interface template for requested web services. When updating or downloading the skeleton file 326, web servers or application servers 302A-302N can refresh or download an updated skeleton file from any one of the one or more centralized servers 306.

Each of the one or more HTML/SGML documents (files) 326 contain one or more embedded tags 328 and other placeholders 330, which a rendering feature 332 of each web server 302 can populate with context-based navigational elements, depending on the service server 302 being accessed by the user. Embedded tags 328 refer to labels for use in markup language for identifying types of information, including information content, navigational elements (such as buttons, menu bars, clickable links, and the like), multimedia elements (such as pictures, sounds, video, and the like) and so on.

When a user accesses a service server (such as service server 302A) via the browser application, the browser application requests a URL (web page) associated with services supported by the particular service server 302A. The rendering feature 332 of the service server 302A captures the web page content coded in the requested URL that is required to populate the layout structure (e.g. embedded tags 328 and placeholders 330) of the skeleton HTML/SGML file 326. The rendering feature 332 then renders (populates) the embedded tags 328 and placeholders 330 of the file 326 and serves the populated document to the user's browser window 310.

The process of “populating” or “rendering” can involve assembling information from one or more locations. In one embodiment, the navigational elements, for example, of the service server 302A accessed by the user are rendered from a file 304A associated with the service server 302A. Navigational elements associated with the overall enterprise are rendered from files 308 accessible from the centralized server 306. Consequently, when a user accesses a web page associated with web server 302A, the server 302A calls rendering feature 332, which interprets the embedded tags 328 and placeholders 330 of the accessed page, and populates them with locally stored navigation code from data 304A and enterprise navigation code from data 308, as needed.

In one embodiment, server code 340 stored on each of the one or more web (service) servers 302A-302N calls the centralized server 306 periodically (such as once per day) to download the skeleton document(s) or file(s) 326, if there are any changes. In another embodiment, an administrative feature 338 is provided on one or more of the centralized servers 306 for triggering the server code 340 on each of the one or more web servers 302 to download (update) their local version of the skeleton file 326. This administrative feature 338 can be a simple administrative program which an administrator of the site can use to perform update functions. Alternatively, the centralized server 306 prompts subscriber servers (such as web server 302A) to perform the download whenever the skeleton file 326 is updated. The server code 340 stored on the web server 302A can then call the centralized web server 306, and update the skeleton file 326. In another embodiment, the skeleton file 326 can be accessed via the network 324, as needed. Since the skeleton file 326 contains layout information for the page, including embedded tags 328, placeholders 330, and navigational code, an entire enterprise can share a consistent look and feel, both in terms of layout and in terms of navigational elements, without having to update web pages on each web server 302. In this manner, changes to web site can be pushed to all associated services and to all of the enterprises web pages simply by altering the code of the skeleton file 326 and uploading the altered skeleton file 326 to the centralized server 306.

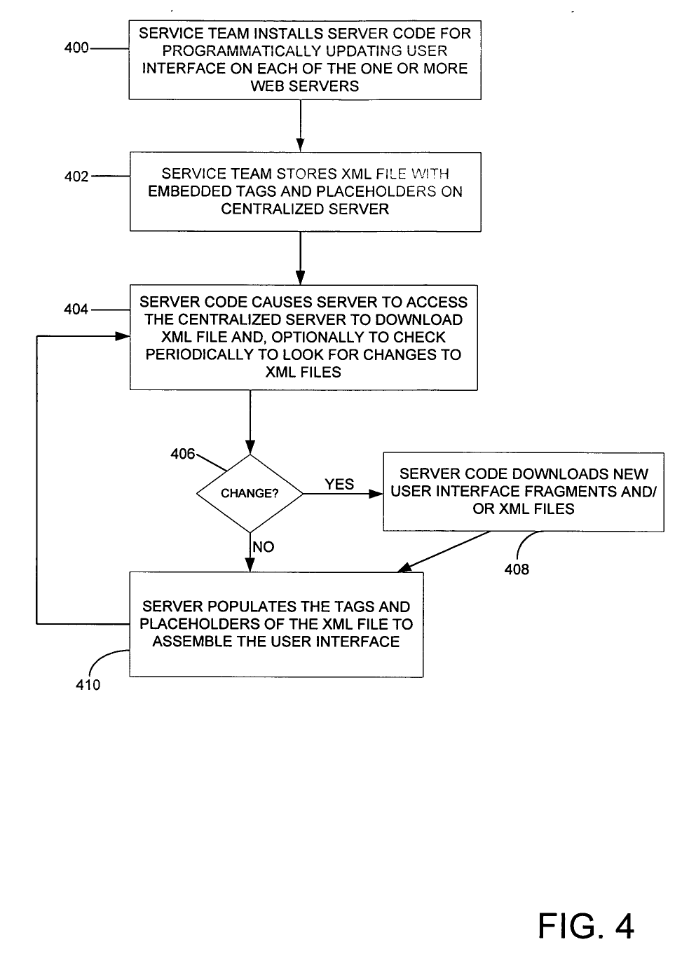

FIG. 4 illustrates a simplified flow diagram of one method for implementing an embodiment of the present invention. As shown, a web site service team or individual installs server code on one or more web servers (step 400). The service team or individual creates an XML (or other markup language) file with embedded tags and placeholders and with for providing a standardized layout and stores the XML file on a centralized server (step 402). In one embodiment, the server code is a dynamic link library (DLL) file, which causes each of the web servers to access the centralized server to retrieve the XML file, and optionally to check periodically to see if the XML file has been updated (step 404). If the XML file has been changed (step 406), the server code downloads the new user interface fragments and/or XML files (step 408). If the XML file has not been changed, or if the server code has previously downloaded the updated files (step 408), then the server captures the data and populates the tags and placeholders of the file with the captured data to assemble the user interface, which includes data and navigational elements (step 410).

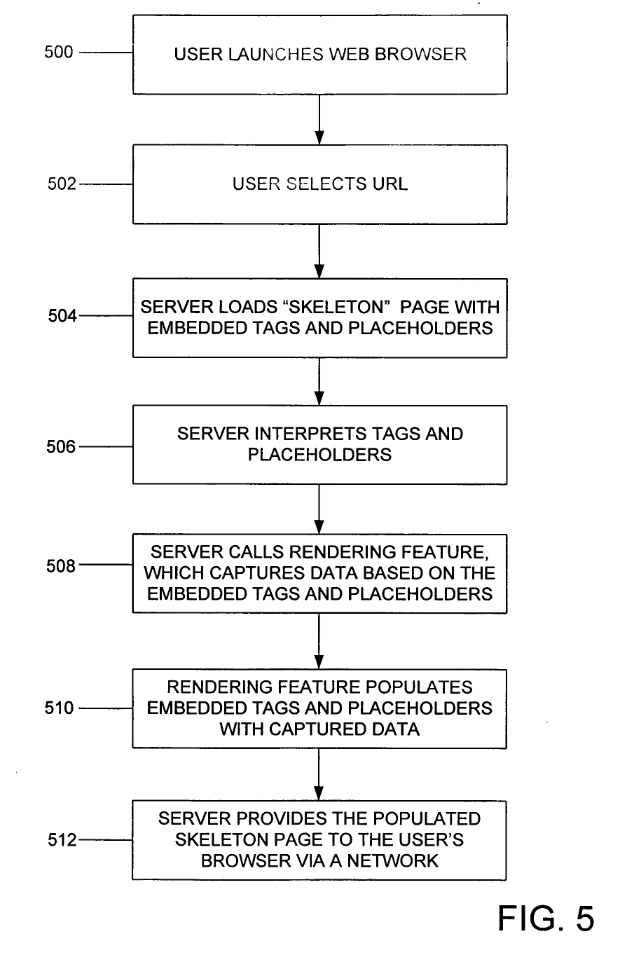

FIG. 5 shows a simplified block diagram of the interaction of an embodiment of the present invention from a perspective of the browser's interaction with the server. As shown, the user launches a web browser application (step 500). The user selects a uniform resource locator (URL) (step 502). The server loads a skeleton page with one or more embedded tags and placeholders, which is associated with the selected URL (typically a file on the one or more service servers or web servers) (step 504). The server interprets the one or more tags and placeholders (step 506). The server calls a rendering feature, which captures data based on the embedded tags and placeholders (step 508). The rendering feature populates the embedded tags and placeholders with the captured data (step 510). The server provides the populated “skeleton” page to the user's browser via a network.

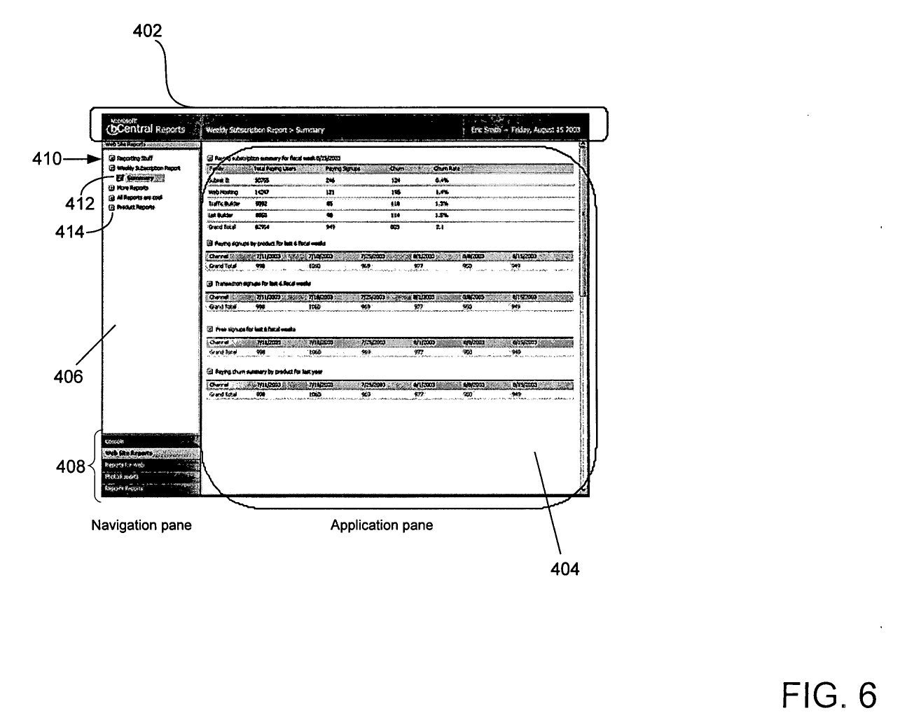

FIG. 6 is a screen view of a web page displayed in a browser window, wherein the navigation pane and the header and footer were constructed by a rendering engine based on navigational elements defined in an XML (or other markup language) document. The layout of the page and enterprise navigation elements may be coded in the skeleton page, along with embedded tags and placeholders, which can be populated by a service server to provide context-based page content with a consistent look and feel. The web page 400 includes a header 402, an application pane 404, and a navigation pane 406. This particular embodiment does not show a footer or an optional navigation pane.

The XML file and the server code allow the web server to be updated readily, across an entire enterprise, with minimal re-coding. Additionally, the change can be implemented enterprise wide instantaneously (as soon as the server has downloaded the updated files), particularly if the web servers are configured to access the skeleton file each time a web service or web page is requested (or if the skeleton file can be pushed onto each of the web servers via an administrative feature). Since enterprise navigational elements can be coded once in the skeleton file and served by the centralized server, overall navigational elements are consistent for all web services offered by the enterprise. By utilizing embedded tags and placeholders in the skeleton file, the individual web servers are allowed to populate the tags and placeholders with context-specific information, including information about the user's preferences, access permission, and the like, which can be used to exercise control over the navigational offerings that are provided to the user.

For example, the navigation pane 406 includes a number of navigation elements in a hierarchical arrangement. At the highest level, the navigation pane 406 offers navigation categories 408 (such as, for example, “console”, “web site reports”, “Reports for Web”, and the like). Of course, these are exemplary only, and other categories could just as easily be used. The category “web site reports” is currently selected. Each navigation category 408 may have one or more subcategories 410, which can be expanded by clicking on the subcategory 410 or its associated expansion icon 414 to reveal submenu items 412. Any number of categories and subcategories can be allowed. In this particular embodiment, selecting a different category causes the currently selected to collapse and causes the newly selected category to expand.

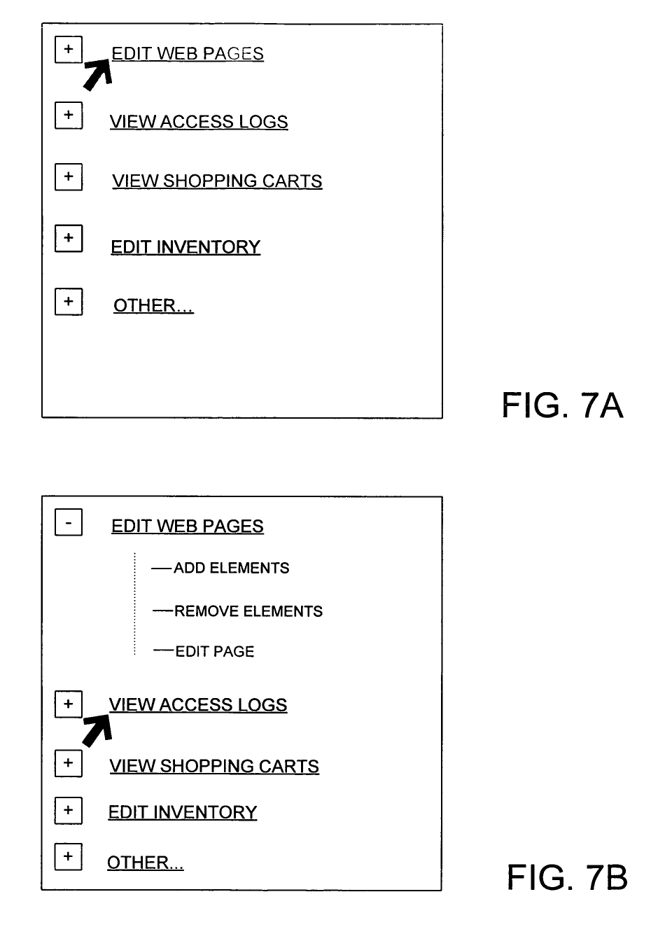

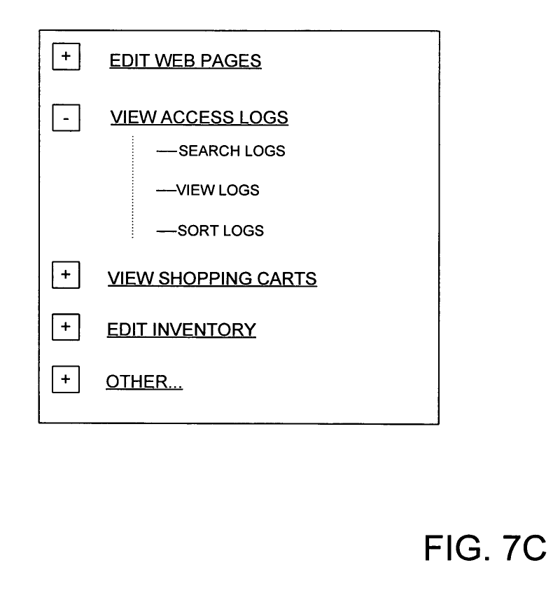

FIGS. 7A-7C illustrate a hierarchical file-tree type arrangement of categories whereby a user can expand and collapse nodes of the tree according to an embodiment of the present invention. As shown, in FIG. 7A, the mouse selector is positioned over the category “Edit Web Pages”. After the user clicks the category, FIG. 7B shows sub-categories available under the “Edit Web Pages” category. FIG. 7C illustrates that after a user clicks on another category, such as “View Access Logs”, the “Edit Web Pages” category collapses, and the “View Access Logs” expands to allow the user to readily access the desired sub-menu options.

This tree-node arrangement can be served, as previously discussed, by populating embedded tags and placeholders of the skeleton file with context-specific data. A user that is authenticated to access only certain types of data can be provided with a tree-node list that includes only those pages to which he or she is permitted access. Such access controls can then be managed by the web server (service server) being accessed by that user.

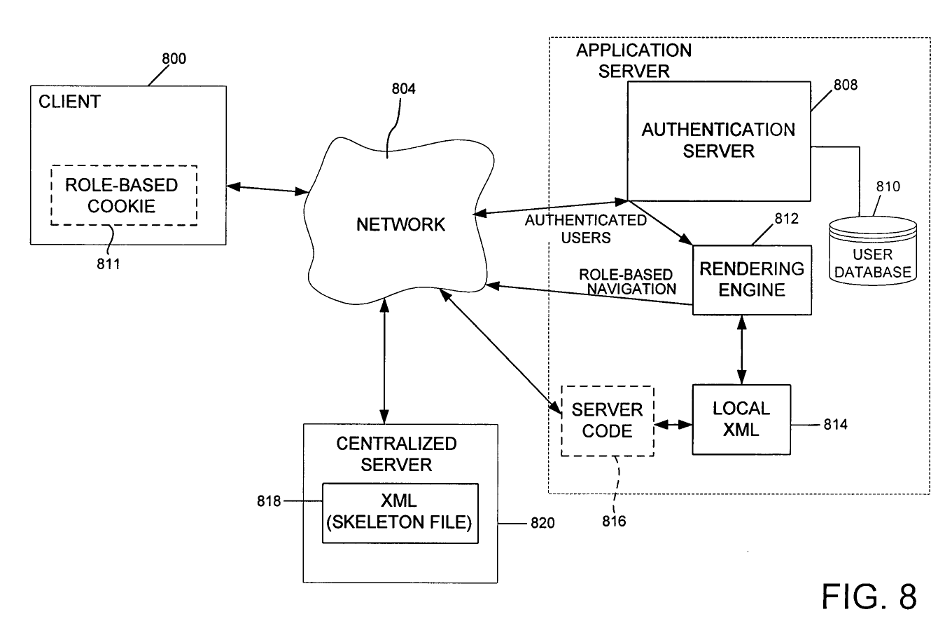

FIG. 8 illustrates an alternative embodiment wherein user access to various navigational elements is controlled by the web server. In particular, a role-based system is briefly described wherein the authenticated user is assigned a role with respect to the server. The role can be encrypted into a cookie or otherwise assigned to the user's session. The role can then be used to determine the user's access privileges when pages are requested, and only options that are available to that user based on his or her access privileges are displayed (or rendered active). In other words, if the user's role does not permit access to a certain options, then the controls associated with those options can either be left out of the navigation pane altogether, or can be rendered as inactive (sometimes referred to as “grayed out” or “ghosted”—meaning that selecting that option causes nothing to happen).

As shown, a client device 800 attempts to access a web page on a remote system 802 via a network 804. The remote system 802 includes a firewall 806, which filters or restricts communication between the network 804 and other elements of the remote system 802. Generally, the firewall 806 is intended to prevent unauthorized access.

User's desiring access to the remote system 802 must provide login information of some sort, either via a digital signature, username and password, secure ID or any other access related login technique. Such information is directed to an authentication server 808, which tests the user information against a user database 810, which contains both the user information and any roles associated with that user. A role is a group or status assigned to a user. For example, one user type that is common on networks is “guest”, which typically allows limited access, if any. Other roles may include, for example, “Administrator”, “Supervisor”, “Legal Counsel”, “Accountant”, and so on. Each of these users may be permitted access to some, but not all, files. Roles may overlap in terms of the access permissions associated with the particular roles; however, in general, a “role” is merely an abstracted grouping of access permissions to files (or in this case navigational elements).

Once a user is authenticated, the authentication server 808 sets a role-based cookie 811 in the client device 800. The role-based cookie can be set to expire within a fixed period of time (such as 12 hours, 1 hour, and the like), or can be set to last only as long as the session.

The firewall 806 generally allows access to authenticated users based on the valid role-based cookie. Requests for web-pages from authenticated users cause the rendering engine 812 (such as a web server) to access the local XML file 814. The local XML file, in this instance, may contain attribute or parameter information associated with the navigational element definitions in the XML file, which the rendering agent 812 utilizes to determine which navigational elements are valid based on the role of each particular user. Thus, a user with a “support staff” role definition would have no navigational element offering access to “Accounting Information”, whereas an Accountant role would cause the rendering engine 812 to draw an “Accounting Information” tab.

While the specific roles described above are roles that might be expected for a corporate intranet, other roles are contemplated, such as “guest”, “registered user”, “silver member”, “platinum member”, “site administrator”, “inventory specialist”, and so on. In an e-commerce setting, “guest”, “registered user”, “silver member” and “platinum member” may refer to a customer's status, such as with a credit card company having different credit cards. The “site administrator” and the “inventory specialist” may have different levels of administrative access to web site elements from the perspective of the corporation that owns the e-commerce site. The options available to each user through the navigation pane would depend on that particular user's authenticated role.

Once the server code is implemented on the web server and the XML navigation code file is added to the central server, the web site administrator or service team can update the navigational options across the entire enterprise simply by updating the XML file on the central server. Changes to the XML file will be effected according to the predetermined time schedule adopted when the server code was installed on the server. If the service team wishes to change the look and feel of the site, without altering the navigation options, the service team simply updates the skeleton file or SML file 818 on the centralized server. In one embodiment, the web servers or service servers updated automatically on a periodic basis (such as every night). Alternatively, the service team can trigger an update event via server code 816 stored on each web server or application server. In this manner, global changes to an Internet web site, for example, can be effected by coding one or two skeleton files, on the centralized server 820, instead of by coding every web page on each web server and application server of an entire enterprise.

Although the present invention has been described with reference to particular embodiments, workers skilled in the art will recognize that changes may be made in form and detail without departing from the spirit and scope of the invention.

1. A system for generating a user interface for display over a network on a user device, the system comprising:
a skeleton file comprising embedded tags and placeholders, the embedded tags defining types of information and control elements, the placeholders defining a layout of the user interface; and
one or more web servers adapted to populate the embedded tags with information and control elements based on interactions of a user.

2. The system of claim 1 further comprising:
a centralized server in communication with the one or more web servers adapted to store a master version of the skeleton file.

3. The system of claim 1 further comprising:
server code stored on the one or more servers and adapted to update the skeleton file from a master version on a centralized server.

4. The system of claim 1 wherein each of the one or more web servers is adapted to host a service for user interaction, and wherein a selected server of the one or more web servers populates the skeleton file from information associated with the hosted service according to interactions of the user.

5. The system of claim 1 wherein the control elements comprise navigational elements within the user interface.

6. The system of claim 1 wherein the control elements with which the one or more web servers populate the embedded tags comprise context-sensitive navigational elements associated with the interaction of the user.

7. A method for generating a user interface for display in an Internet browser application, the method comprising:
hosting a master version of a skeleton file on one or more centralized servers, the skeleton file containing embedded tags defining information types, site navigation elements, and placeholders defining a layout of the user interface; and
distributing programmatically the skeleton file to each of a plurality of web servers for use as a layout template for web pages served by a selected web server based on the interactions of the user.

8. The method of claim 7 wherein the step of distributing comprises:
downloading a copy of the master version of the skeleton file automatically based on server code stored on each of the plurality of web servers; and
storing the downloaded copy on the web server.

9. The method of claim 8 wherein the step of downloading is performed according to a predetermined update schedule.

10. The method of claim 7 wherein the step of distributing comprises:
accessing server code stored on each of the plurality of web servers with an administrative feature of at least one of the one or more centralized servers; and
triggering the server code of each of the plurality of web servers to download a copy of the master version of the skeleton file and to store the downloaded copy.

11. The method of claim 7 further comprising:
capturing data associated with the embedded tags of the distributed skeleton file with the selected web server.

12. The method of claim 11 further comprising:
populating the embedded tags within the distributed skeleton with context-sensitive navigational elements and captured data based on the interactions of the user with the selected web server.

13. The method of claim 7 wherein the skeleton file comprises a computer readable file with embedded tags in a markup language format.

14. The method of claim 13 wherein the markup language format comprises an extensible Markup Language.

15. A system for deployment of context-sensitive navigational elements comprising:
a master definition file comprising embedded tags defining types of information and placeholders defining a layout of a user interface having one or more controls; and
a web server adapted to maintain a local version of the master definition file and to populate the embedded tags with information and local control elements associated with the web server based on interactions of a user.

16. The system of claim 15 wherein the master definition file comprises tagged descriptions of navigational elements of an enterprise system.

17. The system of claim 15 further comprising:
a rendering feature adapted to parse the local version to derive the types of information and the layout of the user interface, the rendering feature adapted to capture information associated with the embedded tags and to populate the embedded tags with the captured information to produce the user interface.

18. The system of claim 15 further comprising:
an authentication server adapted to receive login information of the user and to assign a role to the user based on the login information; and
wherein the information for populating the local version of the master definition file is limited by the web server based on the assigned role.

19. The system of claim 18 wherein the web server populates the local version with navigational elements according to the role assigned to the user

20. The system of claim 15 further comprising:
server code stored on the one or more servers and adapted to update the skeleton file from a master version on a centralized server.

21. The system of claim 1 wherein the master definition file is stored on a central server in network communication with the web server.
